(19) United States
(12) Patent Application Publication
(10) Pub. No.: US 2026/0261635 A1
(43) Pub. Date: Sep. 3, 2026

(54) PROCESSING METHOD, INFORMATION PROCESSING APPARATUS, AND NON-TRANSITORY COMPUTER-READABLE STORAGE MEDIUM STORING PROCESSING PROGRAM

(71) Applicant: SEIKO EPSON CORPORATION, Tokyo (JP)

(72) Inventor: Yuki MORI, Azumino-shi (JP)

(73) Assignee: SEIKO EPSON CORPORATION, Tokyo (JP)

(21) Appl. No.: 19/552,760

(22) Filed: Feb. 27, 2026

(30) Foreign Application Priority Data
Feb. 28, 2025 (JP) 2025-031286

(51) Int. Cl. H04N 9/31; G06T 7/73

(52) U.S. Cl. CPC H04N 9/3185; G06T 7/73; H04N 9/3194

(57) ABSTRACT

An information processing apparatus includes a first processor configured to execute processing related to first imaging when acquiring a plurality of captured images by capturing, with a camera, a pattern image projected on a screen, and a second processor configured to execute processing related to second imaging. The first processor determines whether the pattern image falls within an imaging range by edge detection. The second processor determines whether the pattern image falls within the imaging range using a processing result of the first processor.

The present application is based on, and claims priority from JP Application Serial Number 2025-031286, filed Feb. 28, 2025, the disclosure of which is hereby incorporated by reference herein in its entirety.

### BACKGROUND

### 1. Technical Field

The present disclosure relates to a processing method, an information processing apparatus, and a non-transitory computer-readable storage medium storing a processing program.

### 2. Related Art

JP-A-2013-168119 discloses a mobile terminal apparatus that detects four edge pixel groups continuing in a line segment shape from an image obtained by an imaging unit such as a camera imaging a rectangular object to determine whether vertices of a quadrangle surrounded by straight lines corresponding respectively to four line segments represented by the four edge pixel groups fall within an imaging range of the imaging unit described above.

JP-A-2013-168119 is an example of the related art.

Some projection apparatuses such as projectors have a correction function of correcting a shape of an image to be projected so that an image projected on a screen has a rectangular shape. In the projector having the correction function, a correction value for correcting the shape of the image is calculated based on a plurality of captured images obtained by projecting a pattern image such as a chessboard pattern on the screen and then capturing the pattern image projected on the screen from various angles with the camera. In this case, it is determined whether the pattern image falls within the imaging range for each of the plurality of captured images, but when the processing of detecting the edge pixel group is executed one by one as in the technique disclosed in JP-A-2013-168119, the speed of the processing until the determination result is output decreases.

### SUMMARY

An aspect of a processing method according to the present disclosure includes: acquiring, by at least one processor, in a first period, a first captured image obtained by a camera capturing a screen on which a drawn image including a structured light pattern drawn on a light modulator is projected via a projection lens of a projector; identifying, by the at least one processor, based on the first captured image, a first correspondence relationship in which a coordinate system of the first captured image and a coordinate system of the light modulator are associated with each other; extracting, by the at least one processor, based on a result of an analysis of the screen and the drawn image contained in the first captured image, a plurality of first coordinates corresponding one-to-one to a plurality of first pixels defining a projection area in the first captured image; identifying, by the at least one processor, a plurality of second coordinates in a coordinate system of the light modulator into which each of the plurality of first coordinates is transformed based on the first correspondence relationship; acquiring, by the at least one processor, in a second period subsequent to the first period, a second captured image obtained by the camera capturing the screen on which a drawn image including a structured light pattern drawn on the light modulator is projected via the projection lens; identifying, by the at least one processor, based on the second captured image, a second correspondence relationship in which a coordinate system of the second captured image and the coordinate system of the light modulator are associated with each other; identifying, by the at least one processor, a plurality of third coordinates in the coordinate system of the second captured image into which each of the plurality of second coordinates is transformed based on the second correspondence relationship; and determining, by the at least one processor, whether each of the plurality of third coordinates falls within a range of the second captured image.

Further, an aspect of an information processing apparatus according to the present disclosure includes: at least one processor; and a camera, wherein the at least one processor is configured to execute: acquiring, in a first period, a first captured image obtained by the camera capturing a screen on which a drawn image including a structured light pattern drawn on a light modulator is projected via a projection lens of a projector; identifying, based on the first captured image, a first correspondence relationship in which a coordinate system of the first captured image and a coordinate system of the light modulator are associated with each other; extracting, based on a result of an analysis of the screen and the drawn image contained in the first captured image, a plurality of first coordinates corresponding one-to-one to a plurality of first pixels defining a projection area in the first captured image; identifying a plurality of second coordinates in a coordinate system of the light modulator into which each of the plurality of first coordinates is transformed based on the first correspondence relationship; acquiring, in a second period subsequent to the first period, a second captured image obtained by the camera capturing the screen on which a drawn image including a structured light pattern drawn on the light modulator is projected via the projection lens; identifying, based on the second captured image, a second correspondence relationship in which a coordinate system of the second captured image and the coordinate system of the light modulator are associated with each other; identifying, a plurality of third coordinates in the coordinate system of the second captured image into which each of the plurality of second coordinates is transformed based on the second correspondence relationship; and determining whether each of the plurality of third coordinates falls within a range of the second captured image.

Further, an aspect of a non-transitory computer-readable storage medium storing a processing program according to the present disclosure causes a computer to execute processing including: acquiring, in a first period, a first captured image obtained by the camera capturing a screen on which a drawn image including a structured light pattern drawn on a light modulator is projected via a projection lens of a projector; identifying, based on the first captured image, a first correspondence relationship in which a coordinate system of the first captured image and a coordinate system of the light modulator are associated with each other; extracting, based on a result of an analysis of the screen and the drawn image contained in the first captured image, a plurality of first coordinates corresponding one-to-one to a plurality of first pixels defining a projection area in the first captured image; identifying a plurality of second coordinates in a coordinate system of the light modulator into which each of the plurality of first coordinates is transformed based on the first correspondence relationship; acquiring, in a second period subsequent to the first period, a second captured image obtained by the camera capturing the screen on which a drawn image including a structured light pattern drawn on the light modulator is projected via the projection lens; identifying, based on the second captured image, a second correspondence relationship in which a coordinate system of the second captured image and the coordinate system of the light modulator are associated with each other; identifying, a plurality of third coordinates in the coordinate system of the second captured image into which each of the plurality of second coordinates is transformed based on the second correspondence relationship; and determining whether each of the plurality of third coordinates falls within a range of the second captured image.

### BRIEF DESCRIPTION OF THE DRAWINGS

FIG. 1 is a diagram showing a configuration example of a projection system 1 including an information processing apparatus 10 according to an embodiment of the present disclosure.

FIG. 2 is a diagram showing a configuration example of the information processing apparatus 10.

FIG. 3 is a flowchart showing a flow of processing in the first processing executed by a processing device 140 of the information processing apparatus 10 in accordance with a program PR1.

FIG. 4 is a diagram showing an example of a first captured image.

FIG. 5 is a diagram showing an example of intersections extracted from the first captured image.

FIG. 6 is a flowchart showing a flow of processing in the second processing executed by the processing device 140 of the information processing apparatus 10 in accordance with the program PR1.

FIG. 7 is a diagram showing an example of a second captured image.

FIG. 8 is a diagram showing an example of intersections extracted from the second captured image.

FIG. 9 is a diagram showing an example of intersections extracted from the second captured image.

FIG. 10 is a flowchart showing a flow of processing in the third processing executed by the processing device 140 of the information processing apparatus 10 in accordance with the program PR1.

FIG. 11 is a flowchart showing a flow of processing in the fourth processing executed by the processing device 140 of the information processing apparatus 10 in accordance with the program PR1.

FIG. 12 is a diagram illustrating the content of compensation processing.

FIG. 13 is a diagram illustrating the content of the compensation processing.

FIG. 14 is a flowchart showing a flow of processing in second correction value calculation processing.

FIG. 15 is a diagram illustrating processing of calculating a coordinate system transformation matrix.

FIG. 16 is a diagram illustrating processing of calculating coordinates of four corners after correction.

FIG. 17 is a diagram illustrating the processing of calculating the coordinates of the four corners after the correction.

FIG. 18 is a diagram illustrating the processing of calculating the coordinates of the four corners after the correction.

FIG. 19 is a diagram illustrating the processing of calculating the coordinates of the four corners after the correction.

### DESCRIPTION OF EMBODIMENTS

Various technically preferable limitations are added to an embodiment described below. However, the embodiment of the present disclosure is not limited to an aspect described below.

### A. Embodiment

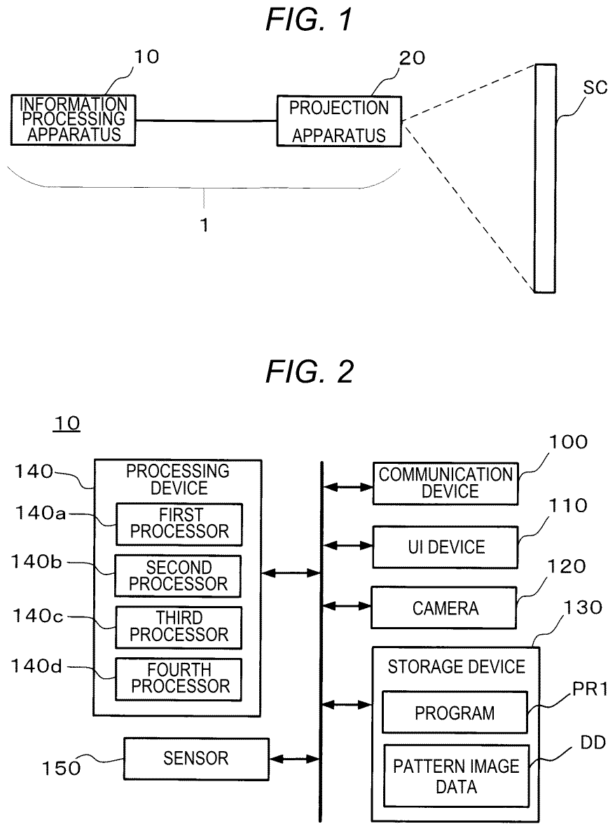

FIG. 1 is a diagram showing a configuration example of a projection system 1 including an information processing apparatus 10 according to an embodiment of the present disclosure. As shown in FIG. 1, the projection system 1 includes a projection apparatus 20 such as a projector in addition to the information processing apparatus 10. The projection apparatus 20 includes a display panel on which an image is drawn, and an optical system that guides, to a screen SC, image light emitted from the display panel. The display panel is an example of a light modulation element, and is a liquid crystal panel in the present embodiment. The light modulation element may be a digital mirror device or the like. In FIG. 1, the display panel and the optical system are not illustrated. The projection apparatus 20 displays an image on the screen SC by projecting image light on the screen SC under the control of the information processing apparatus 10. In the present embodiment, the screen SC is disposed on a wall surface of a room in which the projection apparatus 20 is installed.

The projection apparatus 20 has a correction function of correcting the shape of the image to be projected so that the image projected on the screen SC has a rectangular shape. In the present embodiment, the projection apparatus 20 projects a pattern image such as a chessboard pattern on the screen under the control of the information processing apparatus 10. The information processing apparatus 10 includes a camera, calculates a correction value for correcting the shape of the image based on a plurality of captured images obtained by imaging the pattern image projected on the screen SC from various angles with the camera to set the correction value in the projection apparatus 20.

The information processing apparatus 10 is a smartphone that communicates with the projection apparatus 20 via, for example, a wireless local area network (LAN). FIG. 2 is a diagram showing a configuration example of the information processing apparatus 10. As illustrated in FIG. 2, the information processing apparatus 10 includes a communication device 100, a user interface (UI) device 110, a camera 120, a storage device 130, a processing device 140, and a sensor 150. Each of the communication device 100, the UI device 110, the camera 120, the storage device 130, and the sensor 150 is coupled to the processing device 140 via a bus (not illustrated in FIG. 2). Note that the camera 120 may be a device separate from the information processing apparatus 10 (e.g., a camera connected to the information processing apparatus 10 via the wireless LAN).

The communication device 100 includes an antenna that transmits and receives signals related to wireless communication, and a communication interface circuit that encodes and decodes those signals. The communication device 100 delivers data received, via a wireless LAN or the like, from the projection apparatus 20 to the processing device 140, and transmits, to the projection apparatus 20, data provided from the processing device 140.

The UI device 110 includes an input device including a plurality of operators such as a numeric keypad, and a display device for displaying various images under the control of the processing device 140. Specific examples of the display device include a liquid crystal display. In FIG. 2, the input device and the display device are not illustrated. When an operation such as holding down any of the operators is performed on the input device provided to the UI device 110, the UI device 110 delivers data according to the operation content of the user to the processing device 140. Thus, the operation content of the user is transmitted to the processing device 140.

The processing device 140 includes one processor or a plurality of processors. The processor includes, for example, a central processing unit (CPU). The processing device 140 is an example of a computer in the present disclosure. Although described later in detail, the processing device 140 operates in accordance with the program PR1 stored in advance in the storage device 130 to thereby function as a control center of the information processing apparatus 10. The program PR1 is an example of a processing program in the present disclosure.

The camera 120 includes a CMOS (Complementary Metal-Oxide-Semiconductor) image sensor or a CCD (Charge Coupled Device) image sensor. In the present embodiment, the camera 120 images a capturing area under the control of the processing device 140. The camera 120 outputs image data representing the captured image to the processing device 140. The sensor 150 is, for example, a triaxial acceleration sensor. In the present embodiment, the direction of the gravitational acceleration is identified from the output value of the sensor 150.

The storage device 130 includes a nonvolatile memory such as a flash read-only memory (ROM) and a volatile memory such as a random-access memory (RAM). The nonvolatile memory of the storage device 130 stores the program PR1 for causing the processing device 140 to function as a control center of the information processing apparatus 10, and pattern image data DD representing a chessboard pattern. The volatile memory of the storage device 130 is used by the processing device 140 as a work area when executing the program PR1. When an operation of instructing the UI device 110 to execute the program PR1 is performed, the processing device 140 reads the program PR1 from the nonvolatile memory onto the volatile memory, and then starts executing the program PR1 read onto the volatile memory. The processing device 140 in operation with the program PR1 functions as a first processor 140a, a second processor 140b, a third processor 140c, and a fourth processor 140d.

The first processor 140a executes processing related to first imaging when the screen SC on which the pattern image is projected is imaged a plurality of times from various angles. The second processor 140b executes processing related to second imaging when the screen SC on which the pattern image is projected is imaged a plurality of times from various angles. The third processor 140c executes processing related to third imaging and subsequent imaging when the screen SC on which the pattern image is projected is imaged a plurality of times from various angles. The fourth processor 140d calculates the correction value based on the processing result by the second processor 140b and the processing result by the third processor 140c. The processing method in the present disclosure includes the processing executed by the first processor 140a, the processing executed by the second processor 140b, the processing executed by the third processor 140c, and the processing executed by the fourth processor 140d. A period in which the processing by the first processor 140a is executed is an example of a first period in the present disclosure. A period in which the processing by the second processor 140b is executed is an example of a second period in the present disclosure.

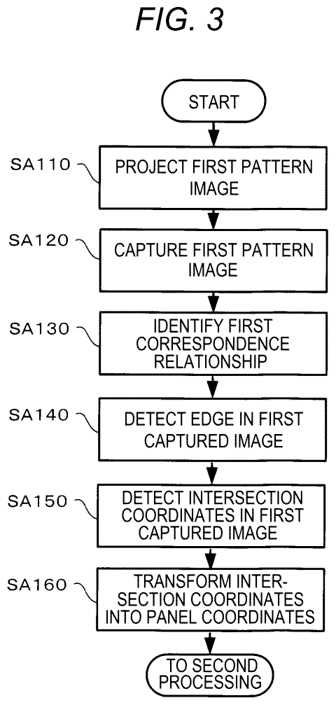

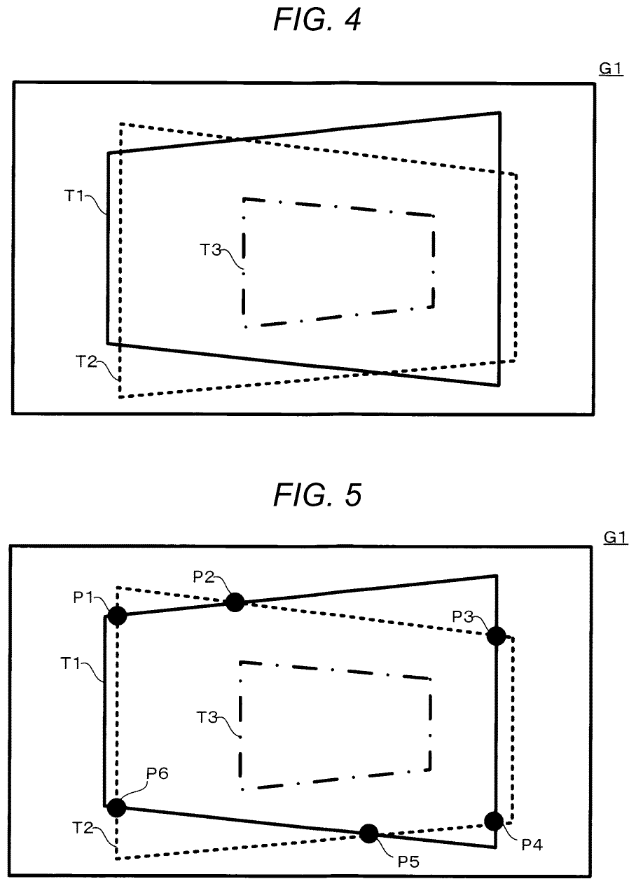

FIG. 3 is a flowchart illustrating a flow of processing in the first processing executed by the first processor 140a. As shown in FIG. 3, the first processor 140a first causes (step SA110) the projection apparatus 20 to project, as the pattern image, a drawn image including an original image such as structured light, and then causes (step SA120) the camera 120 to image the screen SC on which the drawn image is projected via a projection lens of the projection apparatus 20. Then, the first processor 140a acquires, from the camera 120, captured image data representing the captured image captured by the camera 120. The pattern image projected on the screen SC in the first processing is hereinafter referred to as a first pattern image. Further, in the first processing, the captured image captured by the camera 120 is referred to as a first captured image, and the captured image data representing the first captured image is referred to as first captured image data. FIG. 4 is a diagram illustrating an example of the first captured image G1. A quadrangle T1 drawn with a solid line in FIG. 4 corresponds to a frame of the screen SC. In FIG. 4, a quadrangle T2 drawn with a dotted line corresponds to a maximum drawing area in the display panel of the projection apparatus 20, and a quadrangle T3 drawn with a dashed-dotted line corresponds to the first pattern image. As illustrated in FIG. 4, the first pattern image is a small pattern image distributed only around the center of the maximum drawing area in the display panel of the projection apparatus 20. Since the first pattern image is a small pattern image distributed only around the center of the maximum drawing area in the display panel of the projection apparatus 20, the first processor 140a draws, in step SA110, a white image in a margin portion (a portion where the first pattern image is not drawn) in the display panel of the projection apparatus 20. That is, the drawn image projected from the projection apparatus 20 in step SA110 includes the first pattern image and the white image surrounding the first pattern image without a gap.

Note that the first processor 140a is not required to execute step SA110. That is, the pattern image may be projected in response to an operation from the user on the projection apparatus 20 or an operation on a remote controller that remotely operates the projection apparatus 20 instead of a command from the information processing apparatus 10.

Subsequently, based on the first captured image data acquired from the camera 120, the first processor 140a identifies (step SA130 in FIG. 3) a correspondence relationship in which a coordinate system (hereinafter referred to as a camera coordinate system) defining a position on an image represented by the captured image data and a coordinate system (hereinafter referred to as a panel coordinate system) defining a position on the display panel are associated with each other. In order for the first processor 140a to identify the correspondence relationship, a checkerboard pattern, a phase shift pattern, or the like is used as the structured light. An existing technique may be appropriately used to identify the correspondence relationship based on the captured image data. The correspondence relationship identified based on the first captured image data is referred to as a first correspondence relationship. Further, the camera coordinate system that defines a position on the image represented by the first captured image data is referred to as a first camera coordinate system.

Then, the first processor 140a analyzes the screen SC and the drawn image contained in the first captured image G1 to extract a plurality of first coordinates (coordinates in the first camera coordinate system) corresponding one-to-one to a plurality of first pixels defining a projection area in the first captured image G1. The first pixel in the present embodiment is a pixel corresponding to at least one intersection at which a first line segment representing an edge of the drawn image contained in the first captured image G1 and a second line segment representing an edge of the screen SC contained in the first captured image G1 intersect each other, and is also referred to as an intersection pixel.

In a more specific description, the first processor 140a first identifies a plurality of first edge pixels representing edges of the drawn image contained in the first captured image G1 with an existing edge detection algorithm, and then identifies (step SA140 in FIG. 3) the first line segments based on the plurality of first edge pixels. The existing edge detection algorithm is, for example, Canny edge detection. Then, the first processor 140a identifies a plurality of second edge pixels representing edges of the screen SC contained in the first captured image G1, and identifies the second line segments based on the plurality of second edge pixels. In step SA150 subsequent to step SA140, the first processor 140a identifies the intersection pixels corresponding to the intersections of the first line segments and the second line segments, and extracts the coordinates of the intersection pixels in the first camera coordinate system as the first coordinates. FIG. 5 is a diagram showing an example of intersections P1 to P6 extracted from the first captured image G1 shown in FIG. 4.

In step SA160 subsequent to step SA150, the first processor 140a identifies a plurality of second coordinates by transforming each of the plurality of first coordinates into a coordinate in the panel coordinate system based on the first correspondence relationship. The plurality of second coordinates and the plurality of first coordinates correspond one-to-one to each other. By transforming the first coordinate into a coordinate in the panel coordinate system based on the first correspondence relationship, the second coordinate corresponding to that first coordinate is obtained. The flow of the first processing executed by the first processor 140a is as described above. When the execution of the first processing is completed, the second processing is executed by the second processor 140b.

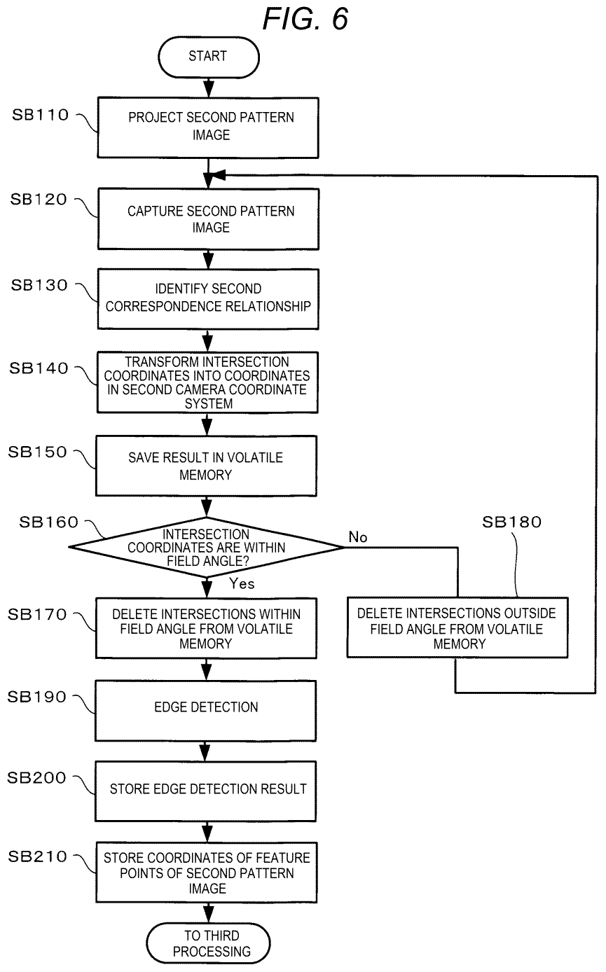

FIG. 6 is a flowchart illustrating a flow of processing in the second processing executed by the second processor 140b. As shown in FIG. 6, the second processor 140b causes the projection apparatus 20 to project (step SB110) the drawn image including the pattern image such as the structured light similarly to the processing in step SA110 in the first processing. Then, the second processor 140b causes the camera 120 to image (step SB120) the screen SC on which the drawn image is projected via the projection lens of the projection apparatus 20, and acquires, from the camera 120, captured image data representing the captured image captured by the camera 120. The pattern image projected on the screen SC in the second processing is hereinafter referred to as a second pattern image. Further, in the second processing, the captured image captured by the camera 120 is referred to as a second captured image, and the captured image data representing the second captured image is referred to as second captured image data. The second processor 140b writes the second captured image data thus acquired to the volatile memory.

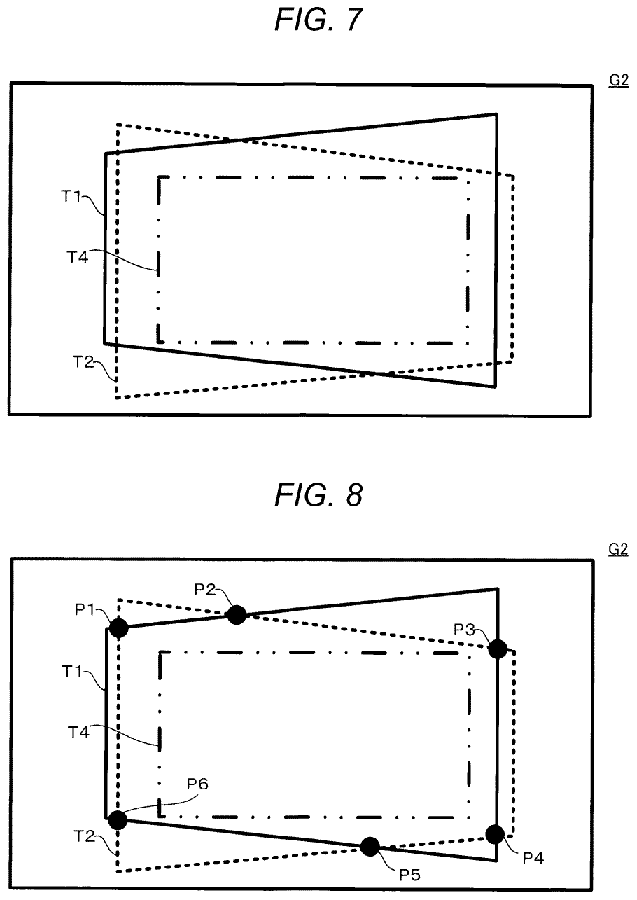

FIG. 7 is a diagram showing an example of the second captured image G2. In FIG. 7, similarly to the case in FIG. 4, the quadrangle T1 drawn with the solid line corresponds to the frame of the screen SC, the quadrangle T2 drawn with the dotted line corresponds to the maximum drawing area in the display panel of the projection apparatus 20, and a rectangle T4 drawn with a dashed-two dotted line represents the second pattern image. As is obvious from a comparison between FIGS. 4 and 7, the second pattern image is larger than the first pattern image. In the present embodiment, the type of the second pattern image is the same as the type of the first pattern image. For example, when the type of the first pattern image is a checkerboard pattern, the type of the second pattern image is also a checkerboard pattern. The type of the second pattern image may be different from the type of the first pattern image. In step SB110, the second processor 140b draws a white image in a margin portion (a portion where the second pattern image is not drawn) in the display panel of the projection apparatus 20. That is, the drawn image projected from the projection apparatus 20 in step SB110 includes the second pattern image and the white image surrounding the second pattern image without a gap.

In step SB130 subsequent to step SB120, the second processor 140b identifies, based on the second captured image data acquired from the camera 120, a correspondence relationship in which a coordinate system (hereinafter referred to as a second camera coordinate system) defining a position on an image represented by the second captured image data and the panel coordinate system are associated with each other. The correspondence relationship identified based on the second captured image data is referred to as a second correspondence relationship.

In step SB140 subsequent to step SB130, the second processor 140b identifies a plurality of third coordinates by transforming each of the plurality of second coordinates into a coordinate in the second camera coordinate system based on the second correspondence relationship. The plurality of third coordinates and the plurality of second coordinates correspond one-to-one to each other. By transforming the second coordinate into a coordinate in the second camera coordinate system based on the second correspondence relationship, the third coordinate corresponding to that second coordinate is obtained. That is, in step SB140, the second processor 140b does not identify the plurality of third coordinates with the edge detection algorithm, but identifies the plurality of third coordinates based on the second correspondence relationship.

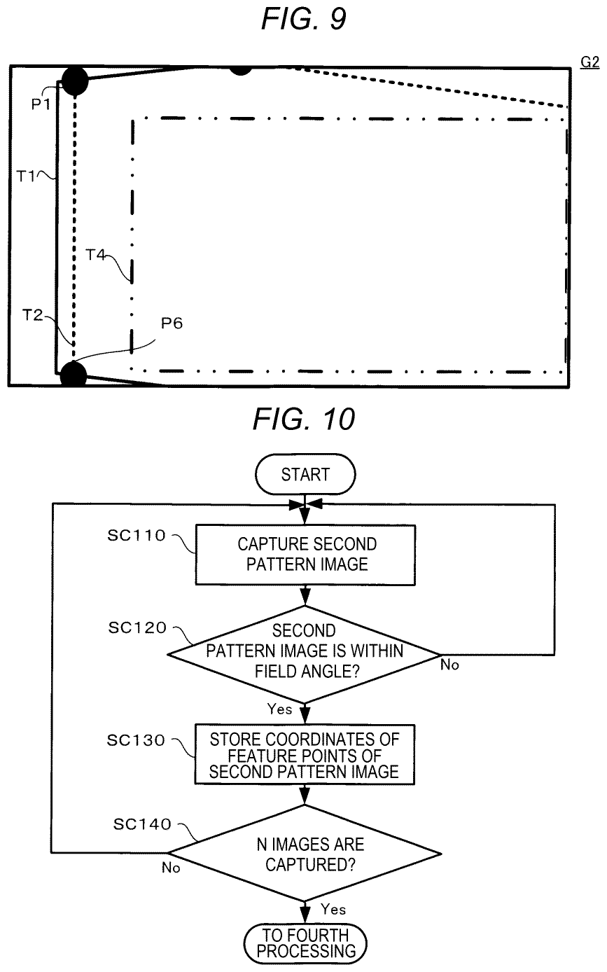

In step SB150 subsequent to step SB140, the second processor 140b stores the plurality of third coordinates by writing the third coordinate data representing the plurality of third coordinates identified in step SB140 into the volatile memory in association with the second captured image data described above. Then, in step SB160 subsequent to step SB150, the second processor 140b determines whether each of the plurality of third coordinates falls within the range of the second captured image G2. For example, the second processor 140b figures out in advance a maximum value of the pixel coordinates in a horizontal direction and a maximum value of the pixel coordinates in a vertical direction in a coordinate system of the second captured image G2, and determines whether each of the plurality of third coordinates falls within a range defined by the maximum value of the pixel coordinates in the horizontal direction and the maximum value of the pixel coordinates in the vertical direction. As shown in FIG. 8, when all of the intersections P1 to P6 corresponding respectively to the plurality of third coordinates fall within the range of the second captured image G2, the determination result in step SB160 is “Yes”. As shown in FIG. 9, when at least one of the intersections P1 to P6 fails to fall within the range of the second captured image G2, the determination result in step SB160 is “No”.

When the determination result in step SB160 is “Yes”, the second processor 140b maintains the state in which the second captured image data is saved in the volatile memory, deletes (step SB170) the plurality of third coordinate data associated with the second captured image data from the volatile memory, and executes processing in step SB190 and subsequent steps. In contrast, when the determination result in step SB160 is “No”, the second processor 140b deletes (step SB180) the second captured image data and the third coordinate data from the volatile memory, and executes once again the processing in step SB110 and subsequent steps. As a result, when the processing in step SB190 and subsequent steps is executed, only the appropriate second captured image data extracted from the first captured image G1 in which all the plurality of intersections are included is saved in the volatile memory. Since the second processor 140b determines whether the second captured image G2 includes the second pattern image at least once using the processing result by the first processor 140a instead of the edge detection algorithm, the processing load is reduced compared to an aspect in which the edge detection is performed one by one to make that determination.

In step SB190 and step SB200, the second processor 140b analyzes the second captured image G2 and stores a plurality of fourth coordinates (coordinates in the second camera coordinate system) corresponding one to one to the plurality of second pixels defining the projection area in the second captured image G2. The second pixel in the present embodiment is a pixel corresponding to the edge corresponding to the frame of the screen SC and a pixel corresponding to the edge of the drawn image. An edge detection algorithm used in step SB190 and step SB200 is the same as the edge detection algorithm used in, for example, step SA140. In the present embodiment, step SB190 and step SB200 are performed after it is determined that the determination result in step SB160 is “Yes”. Therefore, in the present embodiment, it is possible to prevent the second processor 140b from unnecessarily executing the edge detection algorithm.

In step SB210 subsequent to step SB200, the second processor 140b stores coordinates of feature points in the second pattern image. The flow of the second processing executed by the second processor 140b is as described above. When the execution of the second processing is completed, the third processing is executed by the third processor 140c.

FIG. 10 is a flowchart showing a flow of processing in the third processing executed by the third processor 140c. In the third processing, the third and subsequent imaging related to the screen SC on which the drawn image including the pattern image such as the structured light is projected is executed. In the third processing, the second pattern image described above is used as the pattern image to be projected on the screen SC. As shown in FIG. 10, the third processor 140c causes the camera 120 to image the screen SC on which the drawn image including the second pattern image is projected via the projection lens of the projection apparatus 20 to acquire (step SC110) captured image data representing the captured image from the camera 120.

In step SC120 subsequent to step SC110, the third processor 140c determines whether the second pattern image falls within a field angle of the camera 120 by analyzing the captured image data acquired in step SC110. In the determination in step SC120, the coordinates of the intersections are not identified, and whether the second pattern image falls within the field angle of the camera 120 is determined based on the captured image data acquired in step SC110. When the second pattern image falls within the field angle of the camera 120, the determination result in step SC120 is “Yes”. Conversely, when at least a part of the second pattern image protrudes from the field angle of the camera 120, the determination result in step SC120 is “No”. When the determination result in step SC120 is “No”, the third processor 140c outputs a message of, for example, “Please switch the display mode of the pattern image so that the entire pattern image fits within the field angle of the camera” to the UI device 110, and then executes the processing in step SC110 and subsequent steps once again.

When the determination result of step SC120 is “Yes”, the third processor 140c executes the processing in step SC130 and subsequent steps. In step SC130, the third processor 140c stores the coordinates of the feature points in the second pattern image in substantially the same manner as in step SB210 in the second processing.

In step SC140 subsequent to step SC130, the third processor 140c determines whether N (N is an integer no smaller than 2, N=9 in the present embodiment) images have been captured and coordinates of N sets of feature points have been stored. When the determination result in step SC140 is “No”, the third processor 140c executes the processing in step SC110 and subsequent steps. When the determination result in step SC140 is “Yes”, the third processor 140c completes the execution of the third processing, and subsequently, the fourth processing is executed by the fourth processor 140d. In the present embodiment, totally 10 sets of coordinates of the feature points in the captured image acquired by causing the projection apparatus 20 to project the drawn image including the second pattern image and causing the camera 120 to image the screen SC on which that drawn image is projected via the projection lens of the projection apparatus 20 are stored in the volatile memory wherein one set thereof is stored in the second processing and 9 sets thereof are stored in the third processing, and the fourth processing is executed using the coordinates of these 10 sets of feature points. In the present embodiment, N=9 is assumed, but N may be a value no smaller than 2 and no larger than 8, or may be a value no smaller than 10.

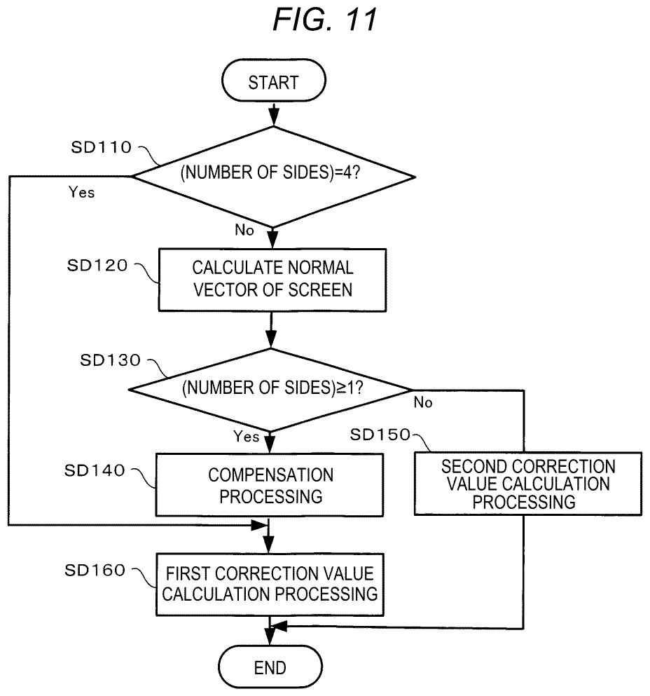

FIG. 11 is a flowchart showing a flow of processing in the fourth processing executed by the fourth processor 140d. The fourth processing is processing of calculating a correction value for correcting a shape of an image projected on the screen SC from the projection apparatus 20 into a rectangular shape. As shown in FIG. 11, the fourth processing includes processing in steps SD110 to SD160. In step SD110, the fourth processor 140d determines whether four sides corresponding to the respective sides of the frame of the screen SC have been detected with reference to the plurality of fourth coordinates written in the volatile memory. When the number of detected sides is 4, the determination result in step SD110 is “Yes”. When the number of detected sides is less than four, the determination result in step SD110 is “No”. When the determination result in step SD110 is “Yes”, the fourth processor 140d executes first correction value calculation processing (step SD160). In the first correction value calculation processing, the fourth processor 140d determines coordinates of four corners of the projection image after the correction so that the image projected from the projection apparatus 20 becomes a rectangle on the screen SC, and transforms those coordinates into coordinates in the panel coordinate system based on the second correspondence relationship. Then, the fourth processor 140d calculates a geometric correction value for distortion correction from the coordinates of those four corners and the coordinates of the four corners of the projection image, and then sets the geometric correction value in the projection apparatus 20.

The fact that the determination result in step SD110 is “No” means that there is missing in the plurality of fourth coordinates corresponding one-to-one to the plurality of second pixels defining the projection area in the second captured image G2, and thus, the first correction value calculation processing described above cannot directly be executed. In step SD120 executed when the determination result in step SD110 is “No”, the fourth processor 140d calculates a normal vector of the screen SC. In more detailed description, the fourth processor 140d calculates a transformation matrix for performing projective transformation of the image on the display panel of the projection apparatus 20 into the captured image of the camera 120 based on each of the coordinates of the ten sets of feature points described above. That is, in the present embodiment, ten transformation matrices are calculated. An existing technique may be appropriately used to calculate these transformation matrices. Then, the fourth processor 140d calculates the normal vector of the screen SC with an optimal path method based on the ten transformation matrices. For details of the optimal path method, see JP Application Serial Number 2024-029280 applied by the present applicant.

In step SD130 subsequent to step SD120, the fourth processor 140d determines whether the number of detected sides is no smaller than 1. When the determination result in step SD130 is “Yes”, the fourth processor 140d executes compensation processing (step SD140) of compensating the plurality of fourth coordinates corresponding one-to-one to the plurality of second pixels defining the projection area in the second captured image G2 and then executes the first correction value calculation processing (step SD160). When the determination result in step SD130 is “No”, the fourth processor 140d executes second correction value calculation processing (step SD150). Details of the second correction value calculation processing will be clarified later.

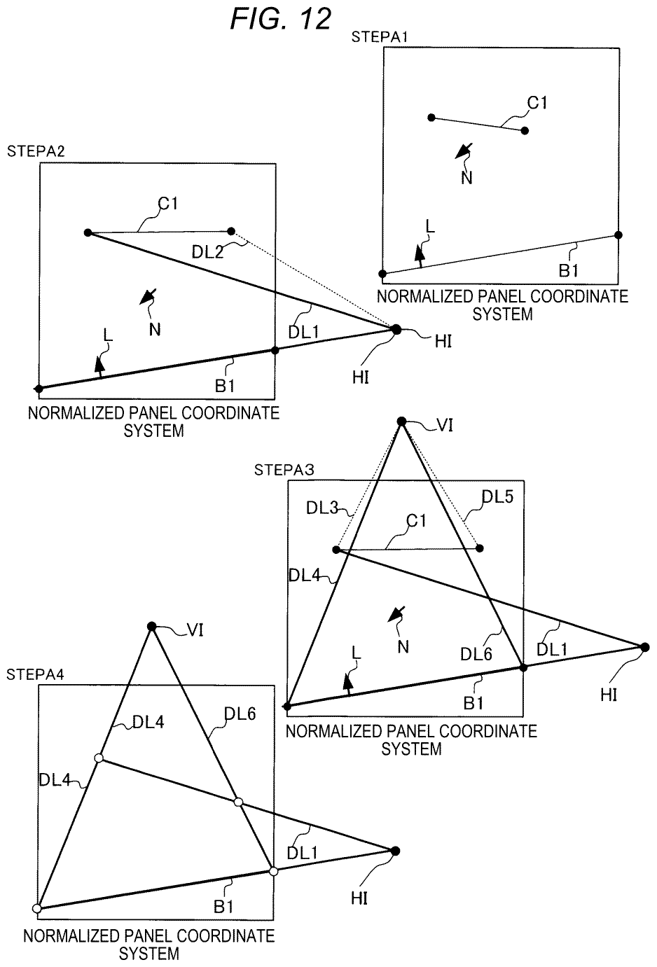

In the compensation processing (step SD140), the fourth processor 140d compensates the plurality of fourth coordinates by compensating undetected sides out of the four sides (the upper side, the lower side, the right side, and the left side) corresponding to the frame of the screen SC based on the sides actually detected out of the four sides and the normal vector of the screen SC. For example, when only the lower side is detected, the fourth processor 140d compensates the missing fourth coordinates by compensating the respective sides of the upper side, the right side, and the left side in manner of STEPA1 to STEPA4 shown in FIG. 12 based on the lower side and the normal vector of the screen SC.

In STEPA1, the fourth processor 140d identifies the normal vector N=(Nx, Ny, Nz) of the screen SC and a normal vector L=(a, b, c) of a linear expression ax+by+c=0 representing the lower side B1 in a normalized panel coordinate system. Since only the lower side B1 of the screen SC is found, the fourth processor 140d identifies a line segment C1 corresponding to an upper end of the display panel in the normalized panel coordinate system instead of the upper side of the frame of the screen SC.

In STEPA2, the fourth processor 140d obtains a coordinate (vector VH) of a horizontal vanishing point HI from a cross product of the normal vector N and the normal vector L identified in STEPA1. Then, the fourth processor 140d sets, as an upper side for screen fitting, the innermost straight line out of a straight line DL1 passing through one end of the line segment C1 and the horizontal vanishing point HI and a straight line DL2 passing through the other end of the line segment C1 and the horizontal vanishing point HI. In the example illustrated in FIG. 12, the straight line DL1 is set as the upper side for screen fitting.

In STEPA3, the fourth processor 140d obtains a coordinate (vector VV) of a vertical vanishing point VI from a cross product of the normal vector N and the vector VH. Then, the fourth processor 140d sets, as a left side for screen fitting, the innermost straight line out of a straight line DL3 passing through a left end of the line segment C1 and the vertical vanishing point VI and a straight line DL4 passing through a left end of the lower side B1 of the screen SC and the vertical vanishing point VI. In the example illustrated in FIG. 12, the straight line DL4 is set as the left side for screen fitting. Similarly, the fourth processor 140d sets, as a right side for screen fitting, the innermost straight line out of a straight line DL5 passing through a right end of the line segment C1 and the vertical vanishing point VI and a straight line DL6 passing through a right end of the lower side B1 of the screen SC and the vertical vanishing point VI. In the example illustrated in FIG. 12, the straight line DL6 is set as the right side for screen fitting.

In STEPA4, since there is a possibility that the vertices corresponding to the four corners of the frame of the screen SC protrude from the projection area, the fourth processor 140d clips the coordinates of the respective vertices such that the vertices protruding therefrom fall within the display panel. Specifically, the fourth processor 140d sets an intersection of the straight line corresponding to the left side for screen fitting and the straight line corresponding to the upper side for screen fitting, an intersection of the straight line corresponding to the right side for screen fitting and the straight line corresponding to the upper side for screen fitting, an intersection of the straight line corresponding to the left side for screen fitting and the lower side B1, and an intersection of the straight line corresponding to the right side for screen fitting and the lower side B1 of the screen SC as vertices of a frame after the compensation. In FIG. 12, these intersections are indicated by open circles.

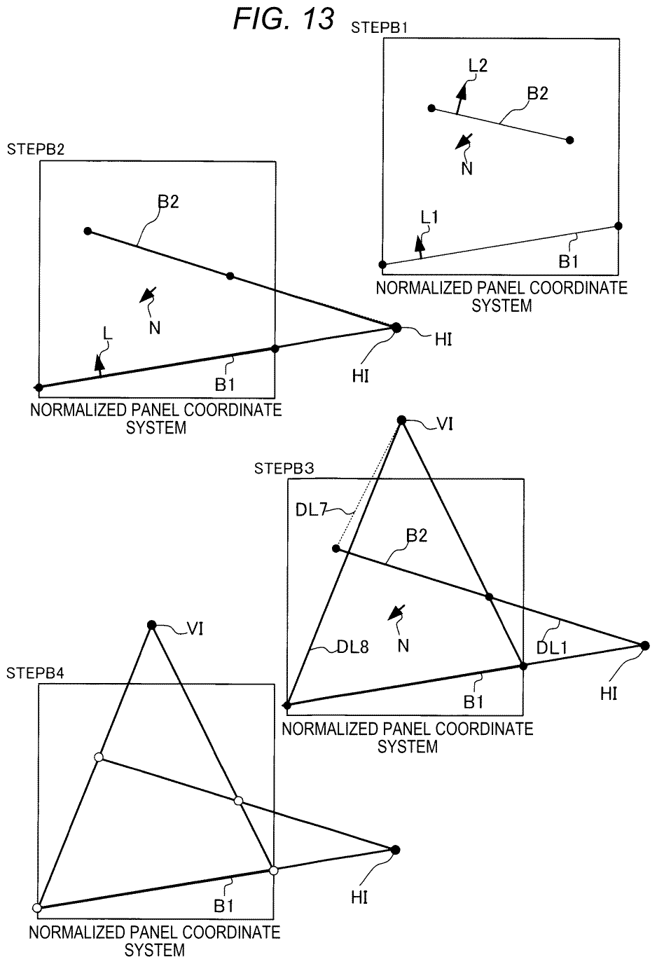

Further, when only the upper side and the lower side of the screen SC have been detected, the fourth processor 140d compensates the missing fourth coordinates by compensating respective sides of the right side and the left side in manner of STEPB1 to STEPB4 shown in FIG. 13 based on the upper side, the lower side, and the normal vector of the screen SC.

In STEPB1, the fourth processor 140d identifies the normal vector N in the normalized panel coordinate system, the normal vector L1=(a1,b1,c1) of a linear expression a1x+b1y+c1=0 representing the upper side, and the normal vector L2=(a2,b2,c2) of a linear expression a2x+b2y+c2=0 representing the lower side.

In STEPB2, the fourth processor 140d obtains the coordinate of the horizontal vanishing point HI using the property that the coordinate of the horizontal vanishing point is obtained by taking a cross product of the normal vectors of the linear expressions in the normalized panel coordinate system. Specifically, the fourth processor 140d obtains the coordinate (vector VH) of the horizontal vanishing point HI from the cross product of the normal vector L1 and the normal vector L2 identified in STEPB1.

In STEPB3, the fourth processor 140d obtains the coordinate (vector VV) of the vertical vanishing point VI from the cross product of the normal vector N and the vector VH. Then, the fourth processor 140d sets, as a left side for screen fitting, the innermost straight line out of a straight line DL7 passing through a left end of the upper side of the screen SC and the vertical vanishing point VI and a straight line DL8 passing through a left end of the lower side of the screen SC and the vertical vanishing point VI. In the example illustrated in FIG. 13, the straight line DL8 is set as the left side for screen fitting. Similarly, the fourth processor 140d sets, as a right side for screen fitting, the innermost straight line out of a straight line passing through a right end of the upper side of the screen SC and the vertical vanishing point VI and a straight line passing through a right end of the lower side of the screen SC and the vertical vanishing point VI. In STEPB4, the fourth processor 140d recalculates the positions of the four vertices of the screen SC in substantially the same manner as in STEPA4 described above, but STEPB4 may be omitted. Further, when only the left side and the right side of the screen SC have been detected, the fourth processor 140d compensates the upper side and the lower side in manner of STEPB1 to STEPB4 based on the left side, the right side, and the normal vector of the screen SC, and in this case, the vector VV is calculated first, and the vector VH is calculated from the cross product of the vector VV and the normal vector N.

Further, when only the upper side and the left side of the screen SC have been detected, the fourth processor 140d compensates the missing fourth coordinates by compensating respective sides of the right side and the lower side in manner of STEPC1 to STEPC5 described below based on the upper side, the left side, and the normal vector of the screen SC.

In STEPC1, the fourth processor 140d identifies the normal vector N in the normalized panel coordinate system, the normal vector L1=(a1,b1,c1) of the linear expression a1x+b1y+c1=0 representing the upper side, and a normal vector L3=(a3,b3,c3) of a linear expression a3x+b3y+c3=0 representing the left side. In STEPC2, the fourth processor 140d obtains the coordinate (vector VV) of the vertical vanishing point from a cross product of the normal vector L3 and the normal vector N. In STEPC3, the fourth processor 140d sets, as the right side, the innermost straight line out of a group of straight lines passing through the vertical vanishing point and intersecting the upper side of the frame of the screen SC. In STEPC4, the fourth processor 140d obtains the coordinate (vector VH) of the horizontal vanishing point from the cross product of the normal vector L1 and the normal vector N. In STEPC5, the fourth processor 140d sets, as the lower side of the screen SC, the innermost straight line out of a group of straight lines passing through the horizontal vanishing point and intersecting the left side of the frame of the screen SC. Note that the fourth processor 140d may recalculate the positions of the four vertices of the screen SC in substantially the same manner as in STEPA4 described above. Further, when only the lower side and the right side of the screen SC have been detected, the fourth processor 140d may compensate the upper side and the left side in manner of STEPC1 to STEPC5 based on the lower side, the right side, and the normal vector of the screen SC.

Then, the second correction value calculation processing will be described.

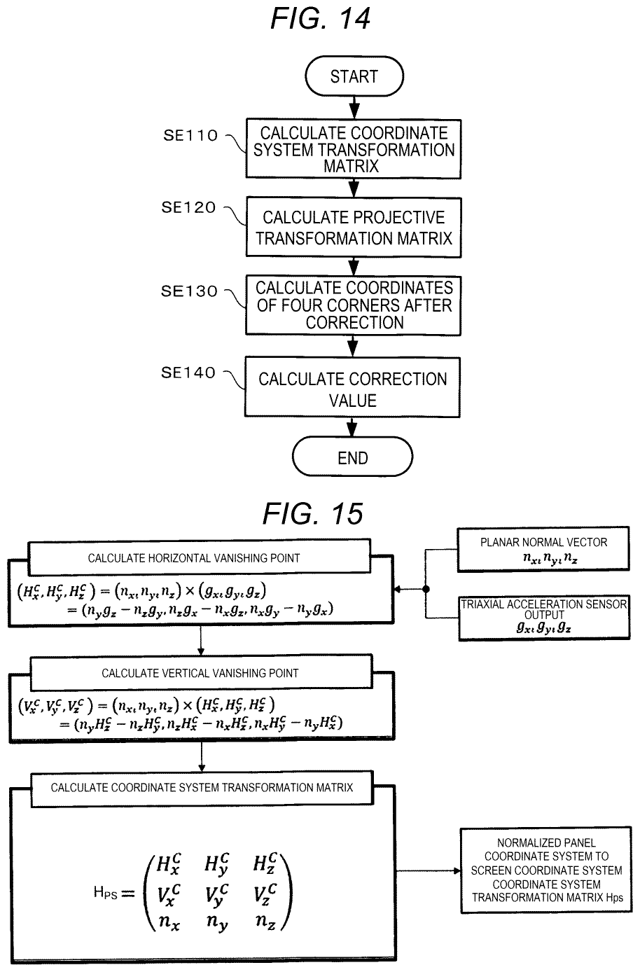

In the second correction value calculation processing, the fourth processor 140d calculates a geometric correction value for distortion correction based on the output value of the sensor 150 and the normal vector of the screen SC to set the geometric correction value in the projection apparatus 20. FIG. 14 is a diagram illustrating a flow of processing in the second correction value calculation processing. In step SE110 in the second correction value calculation processing, the fourth processor 140d calculates a coordinate system transformation matrix H_{PS} for transforming the normalized panel coordinate system into the screen coordinate system based on the output value of the sensor 150 and the normal vector of the screen SC in manner shown in FIG. 15. The screen coordinate system is a coordinate system of the screen SC viewed from the front.

In a more detailed description, the fourth processor 140d first calculates a horizontal vanishing point (vector H^{c}) using the property that the cross product of the vector G indicating the gravitational direction represented by the output value of the sensor 150 and the normal vector N of the screen SC is the X-axis direction in the roll-compensated screen coordinate system. Then, the fourth processor 140d calculates a vertical vanishing point (vector V^{c}) from a cross product of the vector H^{c} and the vector G. Then, the fourth processor 140d calculates the coordinate system transformation matrix H_{PS} based on the vector H^{c} and the vector V^{c}.

In step SE120 subsequent to step SE110, the fourth processor 140d calculates a projective transformation matrix for performing projective transformation of the normalized panel coordinate system into the screen coordinate system based on the transformation matrix for performing projective transformation of the image on the display panel of the projection apparatus 20 into the captured image of the camera 120 and the coordinate system transformation matrix H_{PS}.

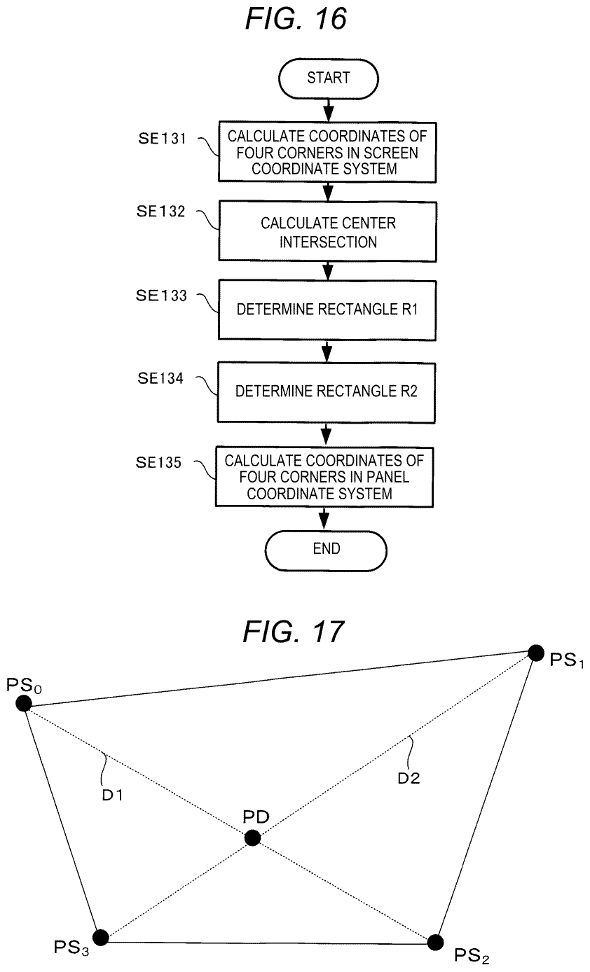

In step SE130 subsequent to step SE120, the fourth processor 140d calculates the coordinates of the four corners after the correction based on the coordinates (a vector PC₀, a vector PC₁, a vector PC₂, and a vector PC₃) of the four corners of the display panel in the normalized panel coordinate system, the resolution of the display panel of the projection apparatus 20, and the projective transformation matrix calculated in step SE120. In the present embodiment, the vector PC₀ corresponds to the coordinate of the upper left corner of the display panel in the normalized panel coordinate system. The vector PC₁ corresponds to the coordinate of the upper right corner of the display panel in the normalized panel coordinate system. The vector PC₂ corresponds to the coordinate of the lower right corner of the display panel in the normalized panel coordinate system. The vector PC₃ corresponds to the coordinate of the lower left corner of the display panel in the normalized panel coordinate system. The coordinates of the four corners of the display panel in the normalized panel coordinate system are calculated from the fourth coordinates described above. As shown in FIG. 16, the processing in step SE130 includes processing in each of steps SE131 to SE135.

In step SE131, the fourth processor 140d calculates the coordinates (a vector PS₀, a vector PS₁, a vector PS₂, and a vector PS₃) of the four corners of the display panel in the screen coordinate system using the following formula (1) based on the vector PC₀, the vector PC₁, the vector PC₂, the vector PC₃, the coordinate system transformation matrix H_{PS}, and a coefficient α determined in accordance to the resolution of the display panel of the projection apparatus 20. In the present embodiment, the vector PS₀ corresponds to the coordinate of the upper left corner of the display panel in the screen coordinate system. The vector PS₁ corresponds to the coordinate of the upper right corner of the display panel in the screen coordinate system. The vector PS₂ corresponds to the coordinate of the lower right corner of the display panel in the screen coordinate system. The vector PS₃ corresponds to the coordinate of the lower left corner of the display panel in the screen coordinate system. Note that in the formula (1), n is one of 0 to 3.

$${H}_{PS} {PC}_{n} = α {PS}_{n} \qquad ( 1 )$$

In step SE132, as illustrated in FIG. 17, the fourth processor 140d identifies a center intersection PD that is an intersection of a diagonal line D1 passing through the upper left corner and the lower right corner of the display panel in the screen coordinate system and a diagonal line D2 passing through the lower left corner and the upper right corner of the display panel in the screen coordinate system.

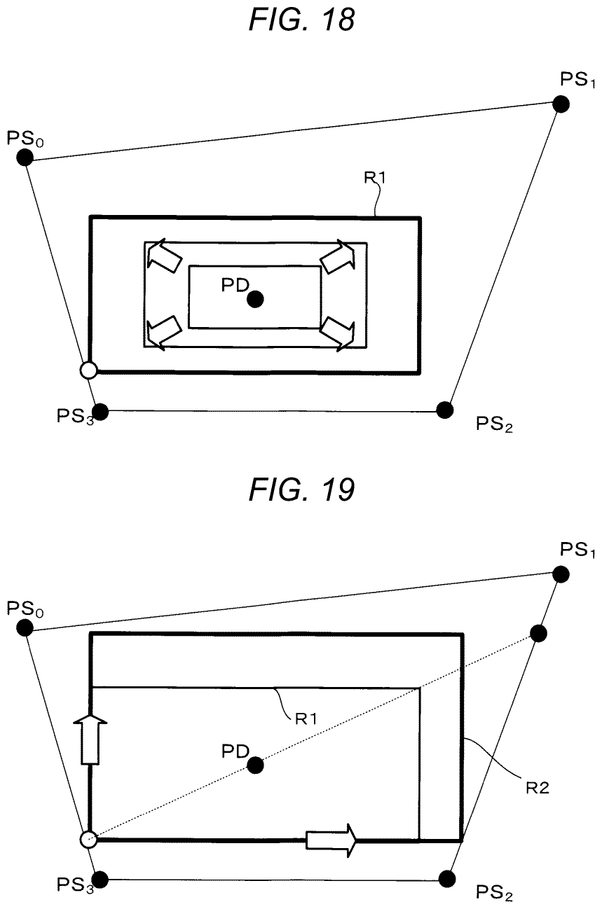

In step SE133, the fourth processor 140d determines a rectangle R1 having a panel aspect ratio centered on the center intersection PD as illustrated in FIG. 18. In a more detailed description, the fourth processor 140d calculates intersections of straight lines directed to the four corners of a rectangle having a desired aspect ratio centered on the center intersection PD and the four outer peripheral sides of the display panel, and searches for an intersection (hereinafter referred to as a reference intersection) the closest to the center intersection PD. Then, by enlarging the rectangle having the desired aspect ratio centered on the center intersection PD, a rectangle which has the desired aspect ratio and has the reference intersection as one of the four corners is determined as the rectangle R1. In the example illustrated in FIG. 18, the rectangle which has the desired aspect ratio centered on the center intersection PD and the lower left corner of which corresponds to the reference intersection is determined as the rectangle R1.

In step SE134, the fourth processor 140d determines a rectangle R2 by enlarging the rectangle R1 with the reference intersection as the origin. In the example illustrated in FIG. 19, the fourth processor 140d enlarges the rectangle R1 in three directions of an upward direction, a rightward direction, and an upper-right direction to calculate intersections with the four outer peripheral sides, determines a rectangle defined by the intersection with the lowest enlargement ratio and the reference intersection as the rectangle R2, and then calculates the four corners (a vector QS₀, a vector QS₁, a vector QS₂, and a vector QS₃) of the rectangle R2.

In step SE135, the fourth processor 140d calculates the coordinates (the vector QC₀, the vector QC₁, the vector QC₂, and the vector QC₃) of the four corners of the display panel after the correction in the normalized panel coordinate system using the following formula (2) based on the vector QS₀, the vector QS₁, the vector QS₂, the vector QS₃, the coordinate system transformation matrix H_{PS}, and the coefficient α described above. Note that in the formula (2), H_{PS}⁻¹ is an inverse matrix of the coordinate system transformation matrix H_{PS}.

$${H}_{PS}^{- 1} {QS}_{n} = α {QC}_{n} \qquad ( 2 )$$

The details of the processing executed by the fourth processor 140d in step SE130 are as described above.

In step SE140 subsequent to step SE130, the fourth processor 140d calculates a geometric correction value for the distortion correction from the vector PS₀, the vector PS₁, the vector PS₂, the vector PS₃, the vector QS₀, the vector QS₁, the vector QS₂, and the vector QS₃, and then sets the geometric correction value in the projection apparatus 20.

According to the present embodiment, the correction value for correcting at least one of the shape and the position of the image projected from the projection apparatus 20 is calculated based on the plurality of fourth coordinates and the second correspondence relationship. According to the present embodiment, an accurate correction value can be calculated using the plurality of recalculated fourth coordinates. Further, since the recalculation is performed only when the second pattern image falls within the field angle, it is possible to prevent unnecessary recalculation, and it is possible to avoid a decrease in speed of the processing until the determination result is output compared to an aspect in which the processing of detecting the edge pixel group is executed one by one.

### B. Modifications

The embodiment described above can be modified as follows.
(1) Prior to the acquisition of the first captured image G1, the processing device 140 may output, to the UI device 110, a message prompting the user to capture the first captured image G1 so as to fall within the field angle.
(2) In the embodiment described above, the processing device 140 of the information processing apparatus 10 that communicates with the projection apparatus 20 via the wireless LAN is made to execute the processing method of the present disclosure. However, a computer of the projection apparatus 20 may be made to execute the determination method of the present disclosure by installing the program PR1 in the projection apparatus 20, and making the computer of the projection apparatus 20 operate in accordance with that program PR1. In this case, the camera 120 may be provided to the projection apparatus 20 or may be connected to the projection apparatus 20 via a wireless LAN or the like.
(3) The first processor 140a, the second processor 140b, the third processor 140c, and the fourth processor 140d in the embodiment described above are the software modules. However, at least one of the first processor 140a, the second processor 140b, the third processor 140c, and the fourth processor 140d may be a hardware module such as an application specific integrated circuit (ASIC). Even when at least one of the first processor 140a, the second processor 140b, the third processor 140c, and the fourth processor 140d is a hardware module, the same advantages as those of the embodiment described above are obtained.
(4) The program PR1 may be manufactured alone, and may be provided for compensation, or without compensation. Specific aspects when providing the program PR1 include an aspect in which the program PR1 is provided by being written in a computer-readable recording medium such as a flash ROM and an aspect in which the program PR1 is provided by being downloaded through an electric communication line such as the Internet.

### C. Summary of Present Disclosure

The present disclosure is not limited to the embodiment and the modifications described above and can be implemented in various aspects without departing from the gist of the present disclosure. For example, the present disclosure can also be implemented by the following aspects. Technical features in the embodiment described above corresponding to the technical features in the aspects described below can be replaced or combined as appropriate in order to solve some or all of the problems of the present disclosure or in order to achieve some or all of the advantages of the present disclosure. Further, the technical features thereof can be deleted as appropriate unless described as essential features in the present specification.

The present disclosure will be summarized below as appendices.

### Appendix 1

An aspect of a processing method according to the present disclosure includes: acquiring, by at least one processor, in a first period, a first captured image obtained by a camera capturing a screen on which a drawn image including a structured light pattern drawn on a light modulation element is projected via a projection lens of a projector; identifying, by the at least one processor, based on the first captured image, a first correspondence relationship in which a coordinate system of the first captured image and a coordinate system of the light modulation element are associated with each other; extracting, by the at least one processor, based on a result of an analysis of the screen and the drawn image contained in the first captured image, a plurality of first coordinates corresponding one-to-one to a plurality of first pixels defining a projection area in the first captured image; identifying, by the at least one processor, a plurality of second coordinates in a coordinate system of the light modulation element into which each of the plurality of first coordinates is transformed based on the first correspondence relationship; acquiring, by the at least one processor, in a second period subsequent to the first period, a second captured image obtained by the camera capturing the screen on which a drawn image including a structured light pattern drawn on the light modulation element is projected via the projection lens; identifying, by the at least one processor, based on the second captured image, a second correspondence relationship in which a coordinate system of the second captured image and the coordinate system of the light modulation element are associated with each other; identifying, by the at least one processor, a plurality of third coordinates in the coordinate system of the second captured image into which each of the plurality of second coordinates is transformed based on the second correspondence relationship; and determining, by the at least one processor, whether each of the plurality of third coordinates falls within a range of the second captured image.

According to the processing method of the present aspect, it is determined whether each of the plurality of third coordinates falls within the range of the second captured image. In the processing method of the present aspect, the plurality of third coordinates defining the area of the drawing image projected on the screen in the second captured image are not extracted by analyzing the second captured image, but the plurality of third coordinates obtained by transforming each of the plurality of second coordinates into the coordinate in the coordinate system of the second captured image based on the second correspondence relationship is used. Therefore, according to the processing method of the present aspect, it is possible to reduce the time required for determining whether each of the plurality of third coordinates falls within the range of the second captured image compared to when analyzing the second captured image acquired in the second period.

### Appendix 2

A processing method according to a more preferable aspect is the processing method according to Appendix 1 further including: saving, by the at least one processor, data of the second captured image in a memory after the at least one processor acquires the second captured image; maintaining, by the at least one processor, a state in which the data of the second captured image is saved in the memory when the at least one processor determines that each of the plurality of third coordinates falls within the range of the second captured image; and deleting, by the at least one processor, the data of the second captured image from the memory when the at least one processor determines that at least one of the plurality of third coordinates does not fall within the range of the second captured image. According to the present aspect, only the appropriate second captured image is saved in the memory.

### Appendix 3

A processing method according to a further preferable aspect is the processing method according to one of Appendices 1 and 2, further including: saving, by the at least one processor, third coordinate data representing the plurality of third coordinates in a memory after the at least one processor identifies the plurality of third coordinates; extracting, by the at least one processor, a plurality of fourth coordinates corresponding one-to-one to a plurality of second pixels defining the projection area in the second captured image, based on the result of the analysis of the screen and the drawn image contained in the second captured image when the at least one processor determines that each of the plurality of third coordinates falls within the range of the second captured image; calculating, by the at least one processor, based on the plurality of fourth coordinates and the second correspondence relationship, a correction value for correcting at least one of a shape and a position of an image projected from the projector; and deleting, by the at least one processor, the third coordinate data from the memory when the at least one processor determines that at least one of the plurality of third coordinates does not fall within the range of the second captured image. According to the present aspect, it is possible to calculate an accurate correction value using the plurality of recalculated fourth coordinates. In addition, since the recalculation is performed only when the image falls within the field angle, unnecessary recalculation can be prevented.

### Appendix 4

A processing method according to a further preferable aspect is the processing method according to one of Appendices 1 to 3, wherein the extracting, by the at least one processor, the plurality of first coordinates includes: identifying a plurality of first edge pixels representing an edge of the drawn image contained in the first captured image; identifying a first line segment representing an edge of the drawn image based on the plurality of first edge pixels; identifying a plurality of second edge pixels representing an edge of the screen contained in the first captured image; identifying a second line segment representing an edge of the screen based on the plurality of second edge pixels; identifying at least one intersection pixel corresponding to at least one intersection at which the first line segment and the second line segment intersect each other; and setting a coordinate of the at least one intersection pixel as the plurality of first coordinates.

### Appendix 5

Further, an aspect of an information processing apparatus according to the present disclosure includes: at least one processor; and a camera, wherein the at least one processor is configured to execute: acquiring, in a first period, a first captured image obtained by the camera capturing a screen on which a drawn image including a structured light pattern drawn on a light modulation element is projected via a projection lens of a projector; identifying, based on the first captured image, a first correspondence relationship in which a coordinate system of the first captured image and a coordinate system of the light modulation element are associated with each other; extracting, based on a result of an analysis of the screen and the drawn image contained in the first captured image, a plurality of first coordinates corresponding one-to-one to a plurality of first pixels defining a projection area in the first captured image; identifying a plurality of second coordinates in a coordinate system of the light modulation element into which each of the plurality of first coordinates is transformed based on the first correspondence relationship; acquiring, in a second period subsequent to the first period, a second captured image obtained by the camera capturing the screen on which a drawn image including a structured light pattern drawn on the light modulation element is projected via the projection lens; identifying, based on the second captured image, a second correspondence relationship in which a coordinate system of the second captured image and the coordinate system of the light modulation element are associated with each other; identifying, a plurality of third coordinates in the coordinate system of the second captured image into which each of the plurality of second coordinates is transformed based on the second correspondence relationship; and determining whether each of the plurality of third coordinates falls within a range of the second captured image. According to the information processing apparatus of the present aspect, similarly to the processing method according to Appendix 1, it is possible to reduce the time required for determining whether each of the plurality of third coordinates falls within the range of the second captured image, compared to the aspect in which the plurality of third coordinates is extracted by analyzing the second captured image.

### Appendix 6

Further, an aspect of a non-transitory computer-readable storage medium storing a processing program according to the present disclosure causes a computer to execute processing including: acquiring, in a first period, a first captured image obtained by the camera capturing a screen on which a drawn image including a structured light pattern drawn on a light modulation element is projected via a projection lens of a projector; identifying, based on the first captured image, a first correspondence relationship in which a coordinate system of the first captured image and a coordinate system of the light modulation element are associated with each other; extracting, based on a result of an analysis of the screen and the drawn image contained in the first captured image, a plurality of first coordinates corresponding one-to-one to a plurality of first pixels defining a projection area in the first captured image; identifying a plurality of second coordinates in a coordinate system of the light modulation element into which each of the plurality of first coordinates is transformed based on the first correspondence relationship; acquiring, in a second period subsequent to the first period, a second captured image obtained by the camera capturing the screen on which a drawn image including a structured light pattern drawn on the light modulation element is projected via the projection lens; identifying, based on the second captured image, a second correspondence relationship in which a coordinate system of the second captured image and the coordinate system of the light modulation element are associated with each other; identifying, a plurality of third coordinates in the coordinate system of the second captured image into which each of the plurality of second coordinates is transformed based on the second correspondence relationship; and determining whether each of the plurality of third coordinates falls within a range of the second captured image. According to the non-transitory computer-readable storage medium storing the processing program of the present aspect, similarly to the processing method according to Appendix 1, it is possible to reduce the time required for determining whether each of the plurality of third coordinates falls within the range of the second captured image, compared to the aspect in which the plurality of third coordinates is extracted by analyzing the second captured image.

What is claimed is:

1. A processing method comprising:
acquiring, by at least one processor, in a first period, a first captured image obtained by a camera capturing a screen on which a drawn image including a structured light pattern drawn on a light modulator is projected via a projection lens of a projector;
identifying, by the at least one processor, based on the first captured image, a first correspondence relationship in which a coordinate system of the first captured image and a coordinate system of the light modulator are associated with each other;
extracting, by the at least one processor, based on a result of an analysis of the screen and the drawn image contained in the first captured image, a plurality of first coordinates corresponding one-to-one to a plurality of first pixels defining a projection area in the first captured image;
identifying, by the at least one processor, a plurality of second coordinates in a coordinate system of the light modulator into which each of the plurality of first coordinates is transformed based on the first correspondence relationship;
acquiring, by the at least one processor, in a second period subsequent to the first period, a second captured image obtained by the camera capturing the screen on which a drawn image including a structured light pattern drawn on the light modulator is projected via the projection lens;
identifying, by the at least one processor, based on the second captured image, a second correspondence relationship in which a coordinate system of the second captured image and the coordinate system of the light modulator are associated with each other;
identifying, by the at least one processor, a plurality of third coordinates in the coordinate system of the second captured image into which each of the plurality of second coordinates is transformed based on the second correspondence relationship; and
determining, by the at least one processor, whether each of the plurality of third coordinates falls within a range of the second captured image.

2. The processing method according to claim 1, further comprising:
saving, by the at least one processor, data of the second captured image in a memory after the at least one processor acquires the second captured image;
maintaining, by the at least one processor, a state in which the data of the second captured image is saved in the memory when the at least one processor determines that each of the plurality of third coordinates falls within the range of the second captured image; and
deleting, by the at least one processor, the data of the second captured image from the memory when the at least one processor determines that at least one of the plurality of third coordinates does not fall within the range of the second captured image.

3. The processing method according to claim 1, further comprising:
saving, by the at least one processor, third coordinate data representing the plurality of third coordinates in a memory after the at least one processor identifies the plurality of third coordinates;
extracting, by the at least one processor, a plurality of fourth coordinates corresponding one-to-one to a plurality of second pixels defining the projection area in the second captured image, based on the result of the analysis of the screen and the drawn image contained in the second captured image when the at least one processor determines that each of the plurality of third coordinates falls within the range of the second captured image;
calculating, by the at least one processor, based on the plurality of fourth coordinates and the second correspondence relationship, a correction value for correcting at least one of a shape and a position of an image projected from the projector; and
deleting, by the at least one processor, the third coordinate data from the memory when the at least one processor determines that at least one of the plurality of third coordinates does not fall within the range of the second captured image.

4. The processing method according to claim 1, wherein
the extracting, by the at least one processor, the plurality of first coordinates includes:
identifying a plurality of first edge pixels representing an edge of the drawn image contained in the first captured image;
identifying a first line segment representing an edge of the drawn image based on the plurality of first edge pixels;
identifying a plurality of second edge pixels representing an edge of the screen contained in the first captured image;
identifying a second line segment representing an edge of the screen based on the plurality of second edge pixels;
identifying at least one intersection pixel corresponding to at least one intersection at which the first line segment and the second line segment intersect each other; and
setting a coordinate of the at least one intersection pixel as the plurality of first coordinates.

5. An information processing apparatus comprising:
at least one processor; and
a camera, wherein
the at least one processor is configured to execute:
acquiring, in a first period, a first captured image obtained by the camera capturing a screen on which a drawn image including a structured light pattern drawn on a light modulator is projected via a projection lens of a projector;
identifying, based on the first captured image, a first correspondence relationship in which a coordinate system of the first captured image and a coordinate system of the light modulator are associated with each other;
extracting, based on a result of an analysis of the screen and the drawn image contained in the first captured image, a plurality of first coordinates corresponding one-to-one to a plurality of first pixels defining a projection area in the first captured image;
identifying a plurality of second coordinates in a coordinate system of the light modulator into which each of the plurality of first coordinates is transformed based on the first correspondence relationship;
acquiring, in a second period subsequent to the first period, a second captured image obtained by the camera capturing the screen on which a drawn image including a structured light pattern drawn on the light modulator is projected via the projection lens;
identifying, based on the second captured image, a second correspondence relationship in which a coordinate system of the second captured image and the coordinate system of the light modulator are associated with each other;
identifying, a plurality of third coordinates in the coordinate system of the second captured image into which each of the plurality of second coordinates transformed based on the second correspondence relationship; and
determining whether each of the plurality of third coordinates falls within a range of the second captured image.

6. A non-transitory computer-readable storage medium storing a processing program causing a computer to execute processing comprising:
acquiring, in a first period, a first captured image obtained by the camera capturing a screen on which a drawn image including a structured light pattern drawn on a light modulator is projected via a projection lens of a projector;
identifying, based on the first captured image, a first correspondence relationship in which a coordinate system of the first captured image and a coordinate system of the light modulator are associated with each other;
extracting, based on a result of an analysis of the screen and the drawn image contained in the first captured image, a plurality of first coordinates corresponding one-to-one to a plurality of first pixels defining a projection area in the first captured image;
identifying a plurality of second coordinates in a coordinate system of the light modulator into which each of the plurality of first coordinates is transformed based on the first correspondence relationship;
acquiring, in a second period subsequent to the first period, a second captured image obtained by the camera capturing the screen on which a drawn image including a structured light pattern drawn on the light modulator is projected via the projection lens;
identifying, based on the second captured image, a second correspondence relationship in which a coordinate system of the second captured image and the coordinate system of the light modulator are associated with each other;
identifying, a plurality of third coordinates in the coordinate system of the second captured image into which each of the plurality of second coordinates is transformed based on the second correspondence relationship; and
determining whether each of the plurality of third coordinates falls within a range of the second captured image.
